(19) United States
(12) Patent Application Publication
(10) Pub. No.: US 2005/0161654 A1
(43) Pub. Date: Jul. 28, 2005

(54) Utility pole installation system and method

(76) Inventor: Perry Wayne Ancell, Valley View, TX (US)

Correspondence Address: KEVIN MARK KLUGHART, 2516 LILLIAN MILLER PARKWAY, SUITE 115, DENTON, TX, 76210-7205, US

(21) Appl. No.: 10/785,582

(22) Filed: Feb. 24, 2004

Related U.S. Application Data
(60) Provisional application No. 60/507,600, filed on Sep. 30, 2003.

(51) Int. Cl. B66D 1/36

(52) U.S. Cl. 254/334

(57) ABSTRACT

A utility pole installation system and method is disclosed which permits utility poles to be installed via the use of a uni-loader or similar device in areas that are space constrained. Specifically, the present invention is advantageously applied to situations where thick brush or other vegetation makes installation and/or replacement of utility poles difficult. The present invention integrates the utility pole installation function by permitting a single uni-loader attachment to (a) drill the earth holes necessary for utility pole installation, (b) place the utility pole in the drilled earthen hole, (c) install necessary guy wire anchors necessary to maintain utility pole stability, and (d) lift transformers and/or other equipment to the top of the utility pole for attachment to the utility pole. The present invention incorporates a structural frame for attachment to a uni-loader, a pole attachment means coupled with a rotating motor means and an articulating piston means to permit manipulation of the utility pole in multiple degrees of freedom, permitting placement of the utility pole in space constrained environments, such as those associated with replacement of existing utility poles or other utility structures.

### CROSS REFERENCE TO RELATED APPLICATIONS

### Provisional Patent Applications

Applicant claims benefit pursuant to 35 U.S.C. § 119 and hereby incorporates by reference Provisional Patent Application for “UTILITY POLE INSTALLATION SYSTEM AND METHOD”, Ser. No. 60/507,600, docket PWA-2003-001, filed Sep. 29, 2003, and submitted to the USPTO with Express Mail Label EV188184763US.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates generally to installation of utility poles and their associated equipment. Additionally, the present invention is particularly applied to situations where existing utility poles must be replaced due to age, deterioration, or damage caused by storms, etc.

Additionally, the present invention is particularly advantageous for use in the installation of utility poles that are constructed of non-wood materials such as FIBERGLAS®, metal, or other non-wood products. While the scope of the invention is not limited to these non-wood products, the present invention is particularly useful in handling these moderately weighted utility poles, as their use is becoming more frequent as a method of reducing deforestation and decreasing the amount of soil contamination associated with wood-based utility pole construction.

### DESCRIPTION OF THE PRIOR ART

The present invention is particularly suited for use in situations where an existing utility pole must be replaced or newly installed in a space-constrained environment. In these situations the existing utility poles may be placed or installed in areas that are space constrained either due to surrounding construction or the growth of various trees and other vegetation. Existing solutions to utility pole installation in these situations has generally involved removal of surrounding trees and other vegetation prior to installation of the new utility pole. This approach may damage or destroy a number of trees and other vegetation resulting in harm to the environment as a result of the installation process. As a result, the installation of utility poles in these environments results in a significant loss of natural resources in the form of trees and other vegetation which is irreversible as the prior art makes no provision for restoration of these natural resources upon installation of the utility pole.

The issue with existing utility pole methods is that the motorized equipment needed for the installation is generally large and cumbersome. Generally, as illustrated in FIG. 1 (0100), the installation equipment comprises truck or tractor-based installation systems (0101, 0102) consisting of a large vehicle (1011, 1012) with a boom mechanism utilized to manipulate the utility pole (1021) or position the installation crew (0122). As a result, it is not possible to position this equipment in space constrained areas (wooded backyards, etc.) where new utility pole installations or replacement installations are required.

Additionally, existing utility pole installation devices are generally limited to one of several functions: pole placement and/or hole drilling (0121) for the utility pole or placement/positioning of pole installation personnel (0122). As a result, multiple tools are generally required for utility pole installation using the prior art.

Furthermore, the prior art generally does not address installation of heavy equipment on the utility pole after the utility pole has been placed. Transformers that are typically placed on utility poles may weigh 300-500 lbs, and as such installation of these and other devices on newly placed utility poles generally requires additional equipment (bucket trucks, etc.) for placement. This greatly increases the equipment complement necessary to affect complete utility pole installation using the prior art. Often, more than one piece of motorized installation equipment is required to affect a utility pole replacement and subsequent equipment installation.

The prior art does teach that uni-loaders of the form illustrated in FIG. 1 (0110) exist, but does not teach the use of these machines in the installation of utility poles, nor does the prior art teach any equipment augmentation of the uni-loader (0110) for the purposes of utility pole installation. Generally, uni-loaders and the like as illustrated (0110) have front-loader (0111) or back-hoe attachments, but have as to date not incorporated any tooling for the express purpose of facilitating utility pole installation.

Note that the uni-loader has a significantly smaller footprint than existing pickup trucks and commercial pole drilling/installation machinery. It also has a significant mobility advantage over existing trucks and heavy machinery.

### OBJECTIVES OF THE INVENTION

Accordingly, the objectives of the present invention are (among others) to circumvent the deficiencies in the prior art and affect the following objectives:
(1) Permit installation of utility poles in space-constrained environments.
(2) Permit use of small form factor uni-loaders and the like to affect utility pole placement and installation.
(3) Permit drilling of earthen holes for utility pole placement.
(4) Permit manipulation of and placement of utility poles in drilled earthen holes.
(5) Permit installation of earthen screw anchors to stabilize utility poles after placement.
(6) Permit lifting and/or installation of transformers and other equipment on placed utility poles.
(7) Permit removal of replaced utility poles in space constrained environments.
(8) Permit utility poles to be installed/replaced in space constrained environments without the need for the unnecessary destruction of trees and other vegetation in the vicinity of the utility pole placement.
(9) To permit the efficient installation of lighter utility poles constructed of FIBERGLAS®, aluminum, steel, and other lightweight materials.
(10) Still another object of the present invention is to permit a single attachment to a uni-loader or similar device to affect complete installation of a utility pole without the need for additional heavy machinery.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention system is generally illustrated in FIGS. 2-19, with an exemplary method embodiment illustrated generally in FIG. 20.

The general structure of the present invention system is illustrated in FIG. 2 (0200) as applied to installation on a CASE® brand uni-loader (0301) as detailed in FIG. 3 (0300). One skilled in the art will recognize that other front-loader devices may be used and that the illustration of the uni-loader is only exemplary of the teachings of the present invention. FIG. 2 (0200) illustrates the basic structure of the present invention incorporating the following elements:
a structural frame (0201) for attachment to a uni-loader;
a pole attachment means (0202), which may be optionally coated to prevent scratching or marring of utility poles and which may include an optional strapping means (0212) for pole attachment;
a rotating motor means (0203) coupled to the pole attachment means (0202) and connected to the structural frame (0201);
an articulating piston means (0204) attached to the rotating motor means (0203) and the structural frame (0201) permitting the pole attachment means (0202) to be moved to the front or rear of the uni-loader;
an optional lifting hook means (0205) which may be useful in lifting and transporting heavy objects such as power transformers;
an optional winching pulley means (0206) used to winch/lift heavy objects such as power transformers to the top of utility poles via utilization of the rotating motor means (0203). This winching pulley means (0206) may optionally be stored via a storage axle (0207) connected to the structural frame (0201).

As seen in FIG. 4 (0400) and detailed in FIG. 5 (0500), FIG. 6 (0600) and FIG. 7 (0700), the combination of the rotating motor means and the articulating piston means permits the pole attachment means to be moved with several degrees of freedom. Additionally, the uni-loader may lift or drop the present invention and thus provide additional degrees of freedom to manipulate the utility pole in space constrained environments, as generally illustrated in FIG. 8 (0800).

### BRIEF DESCRIPTION OF THE DRAWINGS

For a fuller understanding of the advantages provided by the invention, reference should be made to the following detailed description together with the accompanying drawings wherein:

FIG. 1 illustrates a variety of prior art systems used for utility pole installation, hole boring, and utility pole equipment installation;

FIG. 2 illustrates a perspective view of an exemplary embodiment of the present invention;

FIG. 3 illustrates a side installation view of an exemplary embodiment of the present invention as applied to a uni-loader;

FIG. 4 illustrates a perspective view of an exemplary embodiment of the present invention attached to a uni-loader;

FIG. 5 illustrates a perspective view of an exemplary embodiment of the present invention attached to a uni-loader, illustrating rotation of the pole attachment means;

FIG. 6 illustrates a perspective view of an exemplary embodiment of the present invention attached to a uni-loader, illustrating articulation and rotation of the pole attachment means;

FIG. 7 illustrates a side view of an exemplary embodiment of the present invention attached to a uni-loader, illustrating articulation of the pole attachment means and lifting/dropping of the present invention by the uni-loader;

FIG. 8 illustrates a side view of an exemplary embodiment of the present invention attached to a uni-loader, illustrating lifting/dropping of the present invention by the uni-loader in various positions;

FIG. 9 illustrates a perspective view of an exemplary embodiment of the present invention attached to a uni-loader, illustrating use of a drilling attachment attached to the present invention;

FIG. 10 illustrates a side view of an exemplary embodiment of the present invention attached to a uni-loader, illustrating use of a drilling attachment attached to the present invention and the boring of a utility pole hole in the earth;

FIG. 11 illustrates a perspective view of an exemplary embodiment of the present invention attached to a uni-loader, illustrating attachment and lifting of a utility pole with the invention's pole attachment means;

FIG. 12 illustrates a side view of an exemplary embodiment of the present invention attached to a uni-loader, illustrating lifting/articulating of a utility pole with the invention's pole attachment means used in conjunction with the uni-loader's boom;

FIG. 13 illustrates a side view of an exemplary embodiment of the present invention attached to a uni-loader, illustrating articulation/lifting and placement of a utility pole with the invention's pole attachment means used in conjunction with the uni-loader's boom;

FIG. 14 illustrates a perspective view of an exemplary embodiment of the present invention attached to a uni-loader, illustrating use of a drilling attachment used to place a guy wire anchor into the earth;

FIG. 15 illustrates a side view of an exemplary embodiment of the present invention attached to a uni-loader, illustrating use of a drilling attachment and placement of a typical guy wire utility pole support anchor into the earth;

FIG. 16 illustrates a perspective view of an exemplary embodiment of the present invention attached to a uni-loader, illustrating use of the optional lifting hook means to lift a transformer for placement near an installed utility pole;

FIG. 17 illustrates a side view of an exemplary embodiment of the present invention attached to a uni-loader, illustrating use of the optional lifting hook means with uni-loader boom lift to lift a transformer for placement near an installed utility pole;

FIG. 18 illustrates a perspective view of an exemplary embodiment of the present invention attached to a uni-loader, illustrating use of the optional winching pulley means attached to the rotating motor means for use in lifting utility pole equipment into proper position;

FIG. 19 illustrates a perspective view of an exemplary embodiment of the present invention attached to a uni-loader, illustrating use of the optional winching pulley means attached to the rotating motor means to tension a wire used to lift utility pole transformers into proper position;

FIG. 20 illustrates an exemplary method flowchart associated with the use of the present invention in the context of utility pole installation and/or replacement.

These drawings also illustrate the use of the present invention in drilling earthen holes for utility pole placement, installation of a utility pole, and installation of associated utility pole transformer equipment.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a UTILITY POLE INSTALLATION SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Uni-Loader Not Limitive

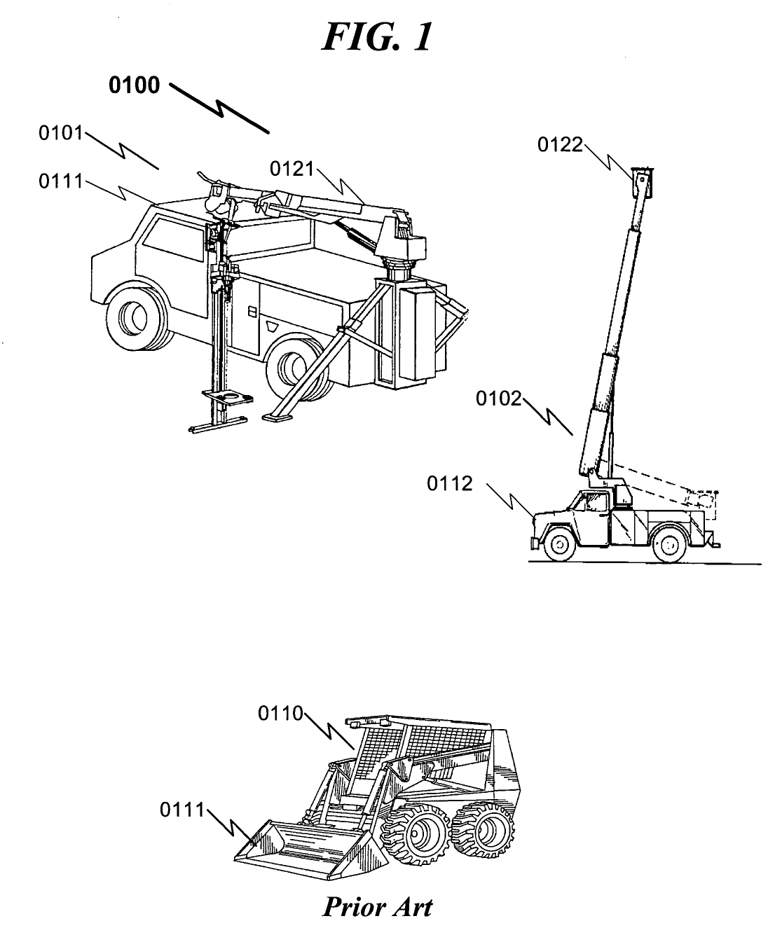

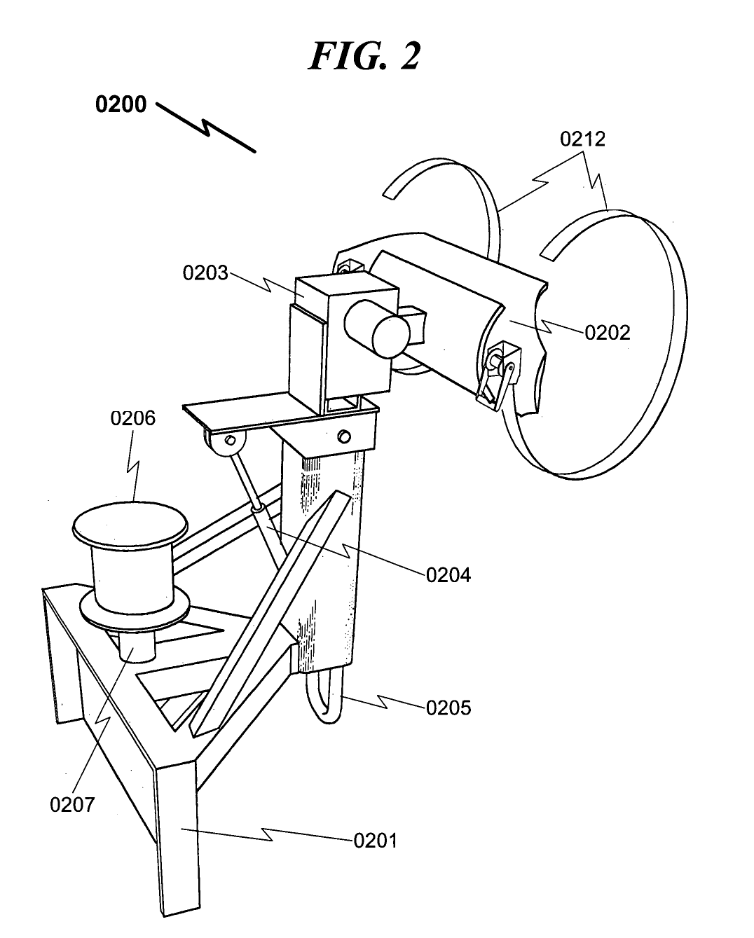

The present invention may be generally applied to uni-loaders as typically illustrated in FIG. 1 (0110), but is not necessarily limited to this type of front-loader or tractor format. The invention as generally illustrated in FIG. 2 (0200) has as one of its features the ability to have a single tool affect (a) drilling the earth holes necessary for utility pole installation, (b) placing the utility pole in the drilled earthen hole, (c) installing necessary guy wire anchors necessary to maintain utility pole stability, and (d) lifting transformers and/or other equipment to the top of the utility pole for attachment to the utility pole.

While the present invention is most notably suited for use with uni-loaders having small form factors, the teachings of the present invention are not necessarily limited to this particular front-loader form factor. Within this context, the term “uni-loader” will be generally used to denote the small form factor versions of various front-loaders well known in the art.

### Exemplary System Embodiment (0200, 0300)

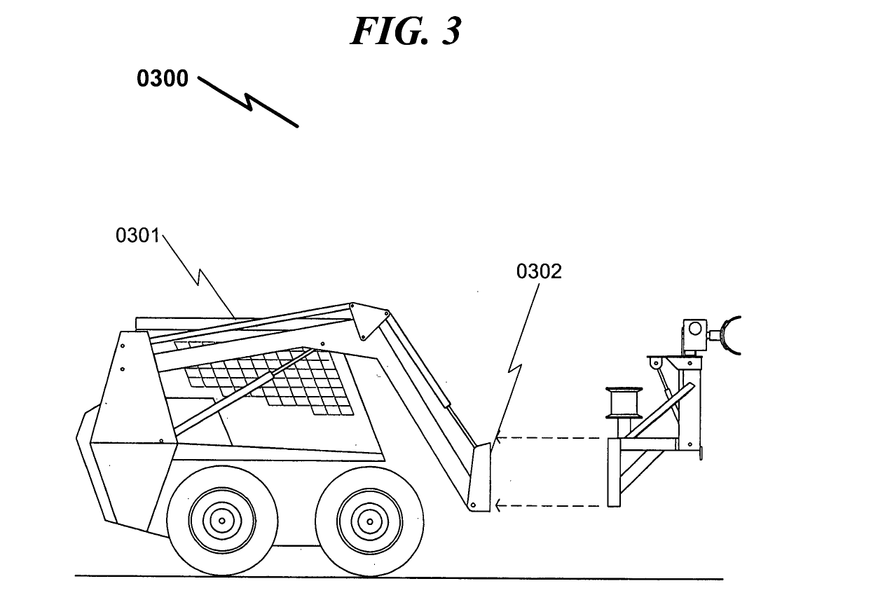

The present invention as generally illustrated in FIG. 2 (0200) consists of a structural frame (0201) which may be attached to a front-loader/uni-loader as generally depicted in FIG. 3 (0300). Note that the hydraulic connections between the uni-loader and the present invention have been omitted for drawing clarity, but generally consist of standard hydraulic couplings well known to those skilled in the art. Additionally, the mating format for connection to the uni-loader (0301) as detailed in (0302) may take a variety of forms with no loss of generality in the invention. As illustrated in FIG. 1 (0111), uni-loaders may have a variety of boom attachments, and the present invention structural frame (0201) may be modified as needed to support connection to a variety of boom configurations.

The selection front-loader/uni-loader mechanized construction equipment is based on the general requirement that many utility pole installations and replacements must occur in space constrained environments, and as such normal construction equipment is too large to be practical in these situations.

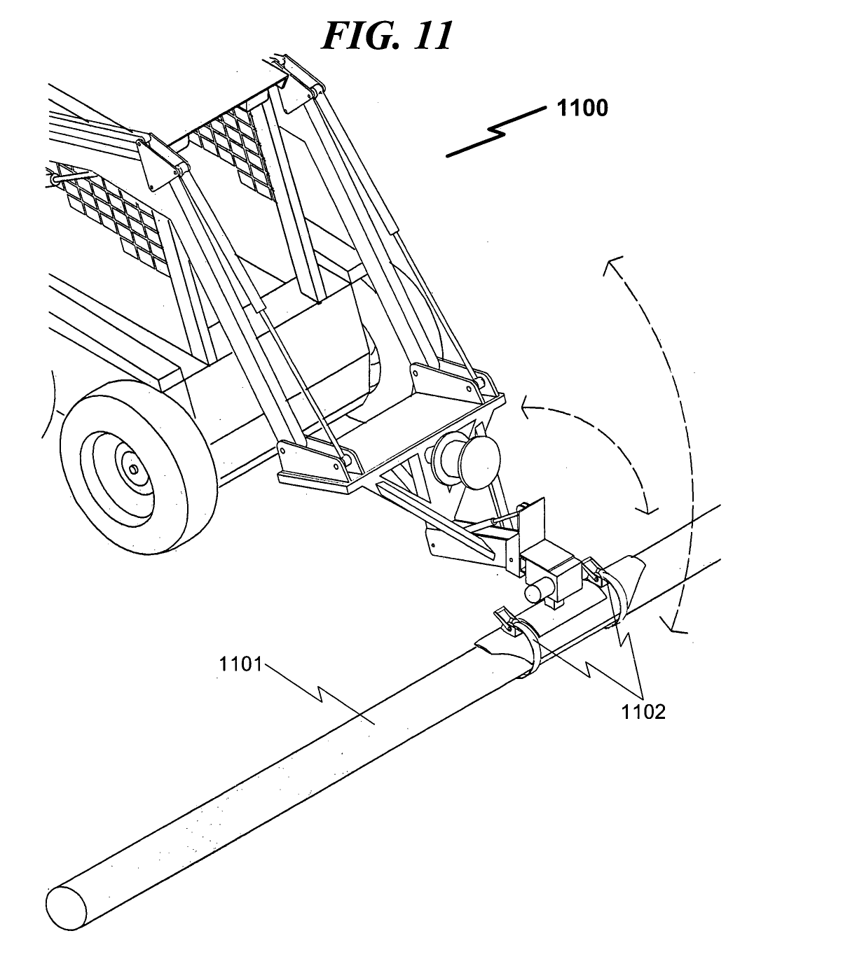

Referencing FIG. 2, the structural frame (0201) holds a rotating motor means (0203) which may be hydraulic, but some embodiments may have this being electrically controlled. This rotating motor means (0203) is attached to a pole attachment means (0202) which is generally formed as a half-cylinder metal plate structure that mates to the outer surface of the utility pole to be installed, as detailed in FIG. 11 (1100). This pole attachment means (0202) may have straps or other attachment means for attachment (0212) and may also be coated with plastic or other material to prevent marring of the utility pole to be installed.

### Exemplary System Movement (0400, 0500, 0600, 0700, 0800)

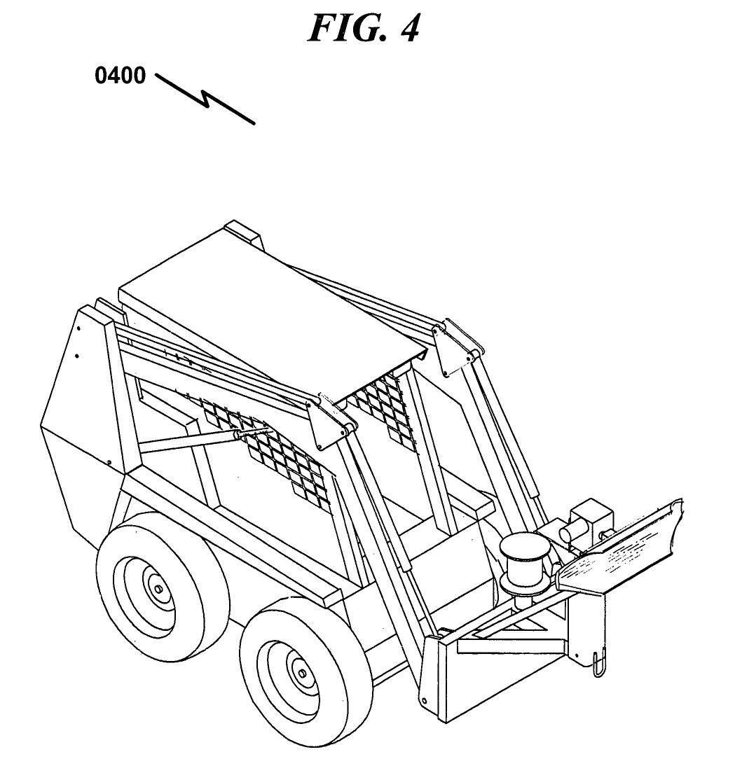

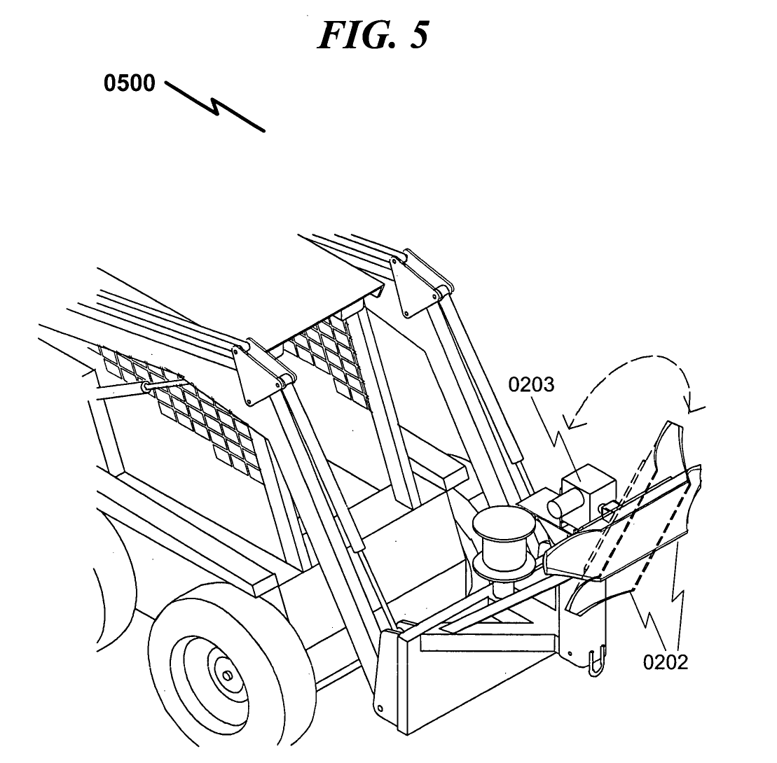

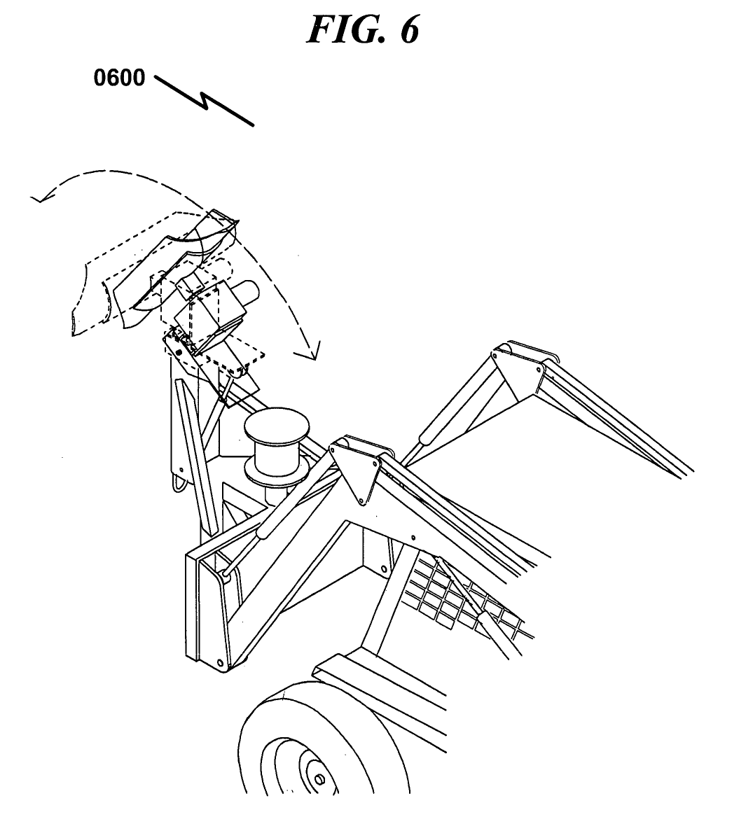

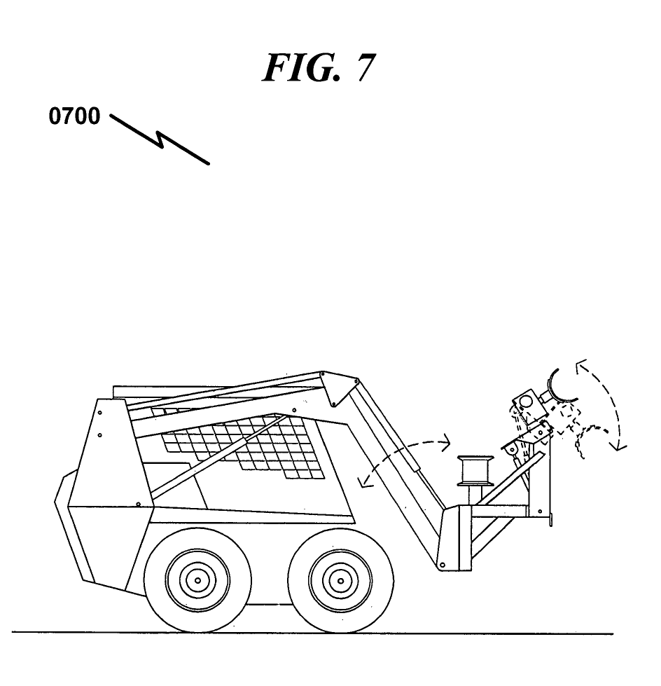

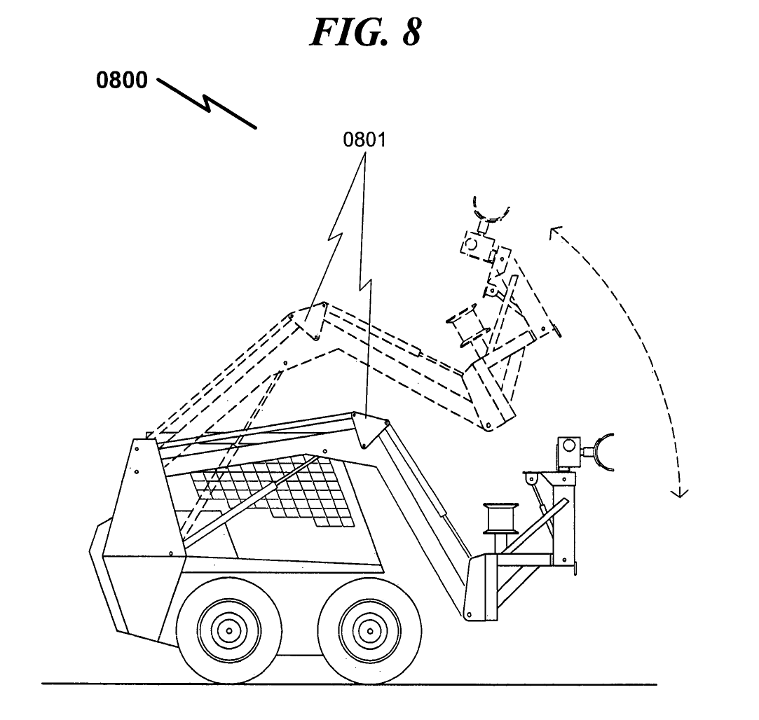

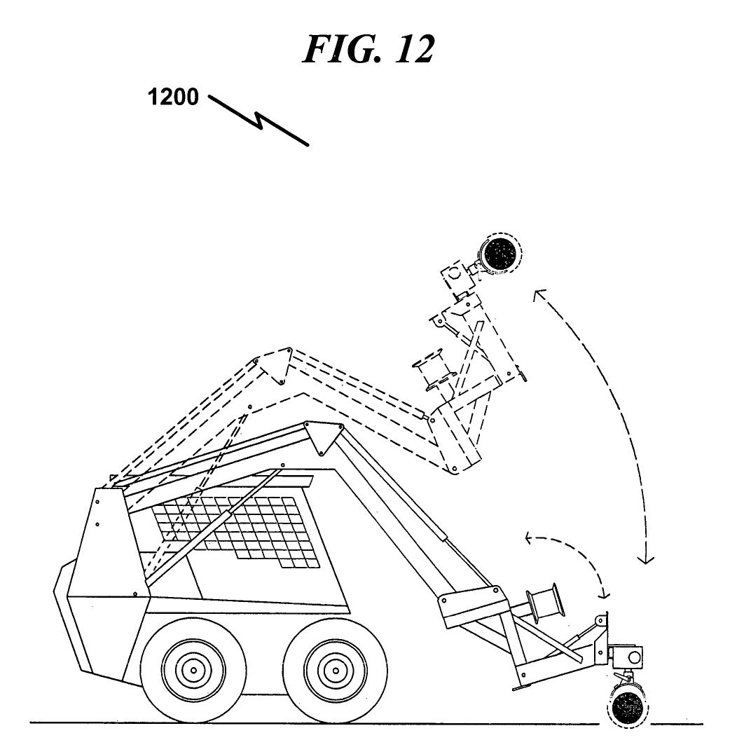

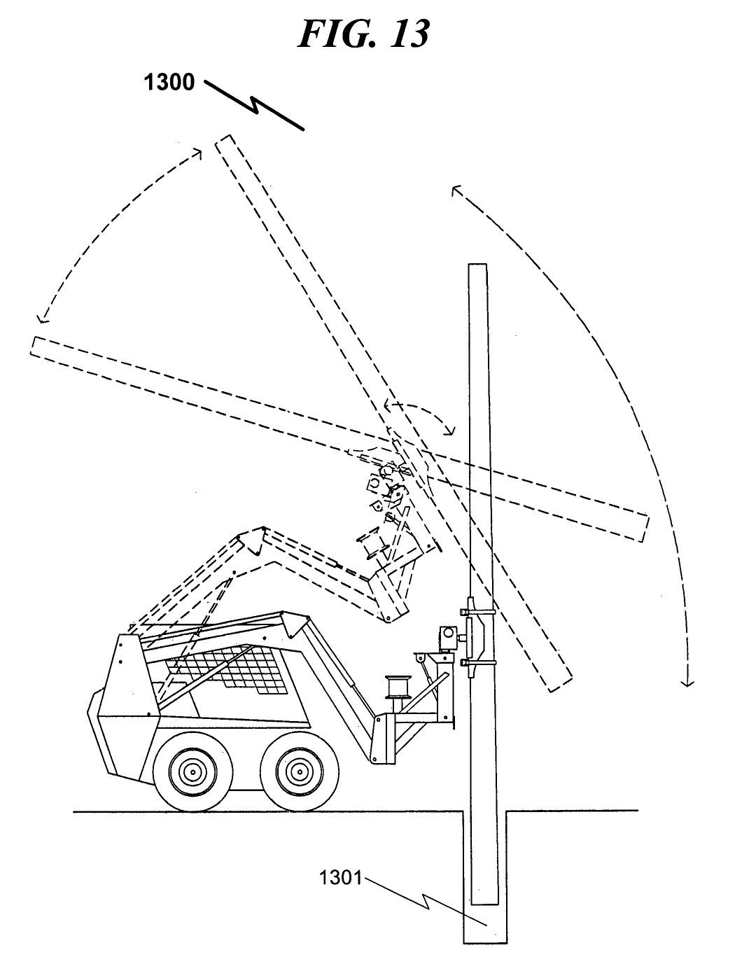

As illustrated in FIG. 4 (0400), FIG. 5 (0500), FIG. 6 (0600), FIG. 7 (0700) and FIG. 8 (0800), the rotating motor means (0203) is connected to the structural frame (0201) and one end of an articulating piston means (0204) which permits the rotating motor means (0203) (and pole attachment means (0202)) to articulate in a line above the uni-loader. This articulation means (0204) and the rotating motor means (0202) permits the attached utility pole to be moved with a number of degrees of freedom, as well as being lifted above the uni-loader. This flexibility and small form factor permits the utility pole to be placed in space constrained environments, as illustrated in the pole installation sequence detailed in FIG. 11 (1100), FIG. 12 (1200), and FIG. 13 (1300).

Note in FIG. 5 (0500) and FIG. 6 (0600), the pole attachment means (0202) may be rotated in a variety of positions to affect utility pole placement. This rotation is directed by the rotating motor means (0203). FIG. 7 (0700) and FIG. 8 (0800) indicate that the uni-loader boom (0801) may be raised up or down.

Generally all that is needed is approximately 7 ft in vertical height and 6 feet in width to permit utility pole insertion, a significant reduction as compared to other installation methods using heavy equipment. As contrasted with the prior art configurations in FIG. 1 (0100), the present invention differs in that the uni-loader attachment (0200) has a small form factor, can be placed in front of a small form factor tractor, and has all of the tools necessary to affect utility pole placement in one combination tool assembly.

### Exemplary Drilling Embodiment (0900, 1000)

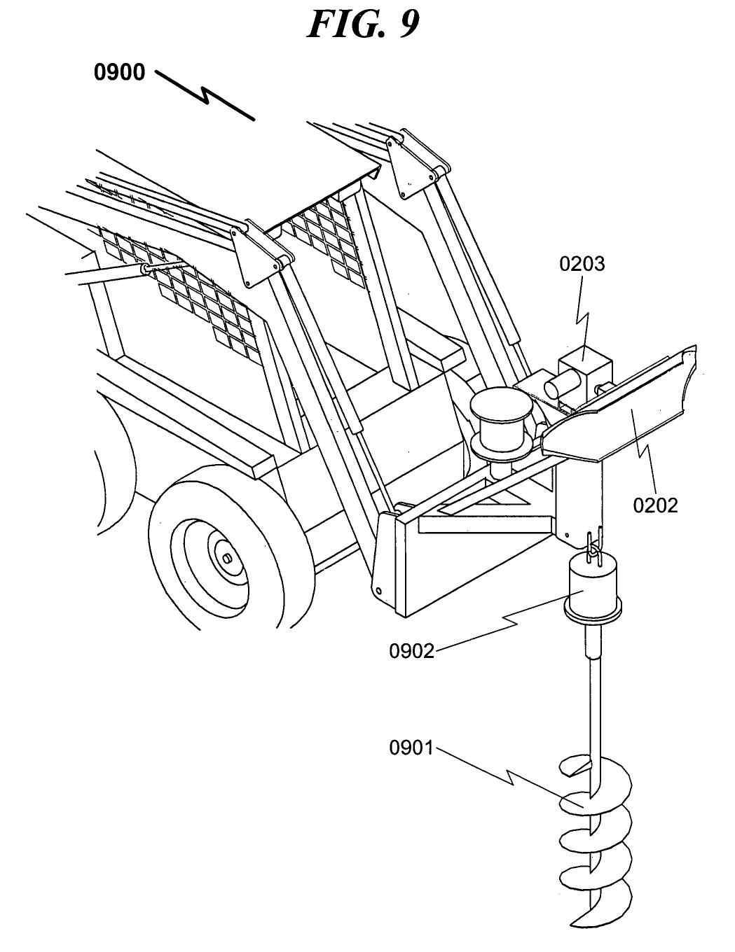

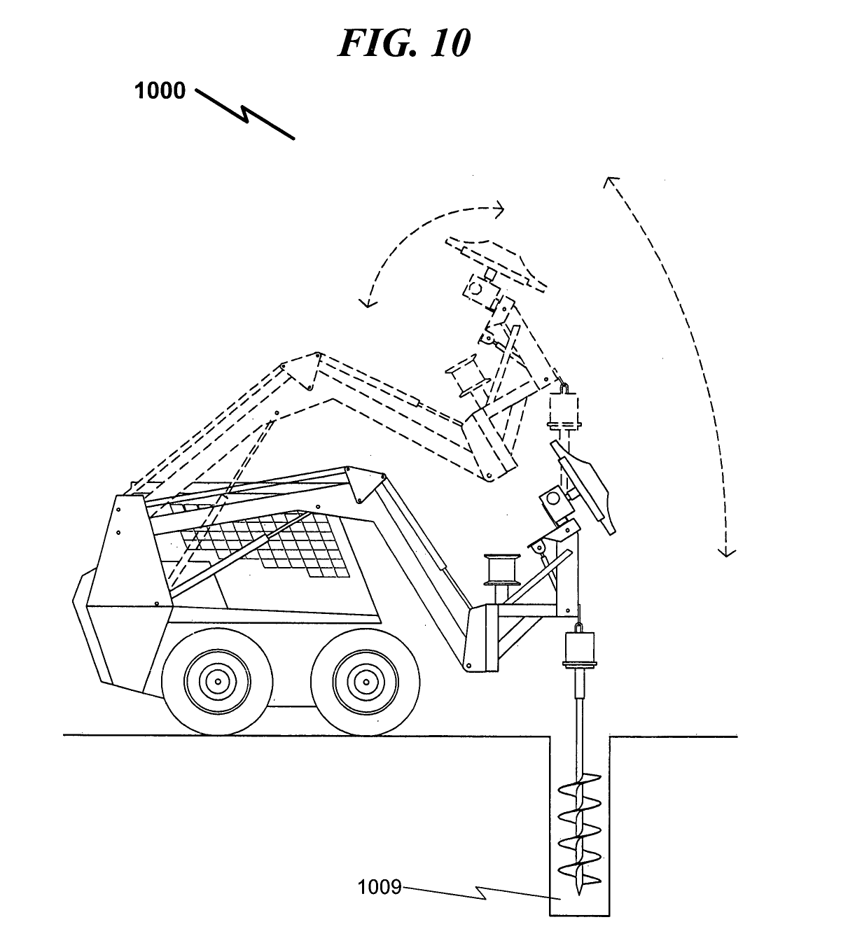

FIG. 9 (0900) and FIG. 10 (1000) illustrate how the present invention may be used with a drilling attachment (0901) to affect the drilling of earthen holes (1009) for use with utility pole placement. Here the pole drilling bit (0901) is attached to a rotating motor means (0902) used to provide torque to spin the drill bit (0901) and affect hole (1009) placement.

Note that FIG. 9 (0900) and FIG. 10 (1000) illustrate the use of a separate rotating motor means (0902) to place the drill bit (0901). However, it may be possible in some situations to use the same rotating motor means (0203) used to articulate and place the utility pole (the pole attachment means (0202)) to provide torque to the drill bit (0901). In this embodiment the pole attachment means (0202) is removed from the rotating motor means (0203) and the drill bit (0901) is attached directly to the rotating motor means (0203). The illustration provided here is just another possible embodiment.

Note that the loop hook on which the rotating motor means hangs in FIGS. 43-46 may also be used to hang transformers or utility poles for dragging or hauling to the jobsite as needed. Additionally, the rotating motor means as illustrated in FIGS. 43-46 may also be used to spin and place guy wire anchors for stabilization of the utility pole once it is placed in the earthen hole.

### Exemplary Pole Placement Embodiment (1100, 1200, 1300)

FIG. 11 (1100), FIG. 12 (1200), and FIG. 13 (1300) illustrate how the present invention may be used to place a utility pole (1101) in a pre-drilled earthen hole (1301). The process utilizes the pole attachment means and several strapping means (1102) as illustrated in FIG. 11 (1100). Once the utility pole is attached to the invention the uni-loader is activated to lift the utility pole and place it in the earthen hole as illustrated in FIG. 12 (1200) and FIG. 13 (1300).

### Exemplary Anchoring Embodiment (1400, 1500)

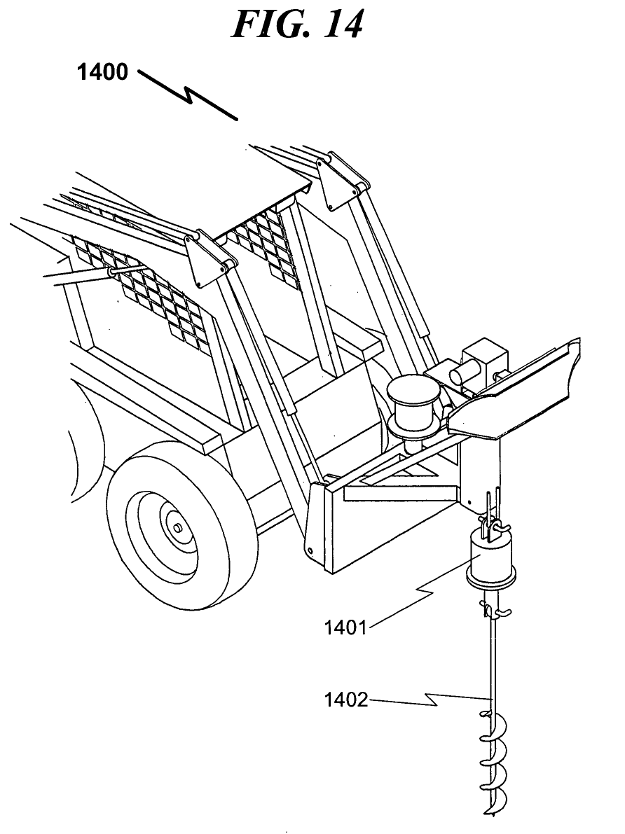

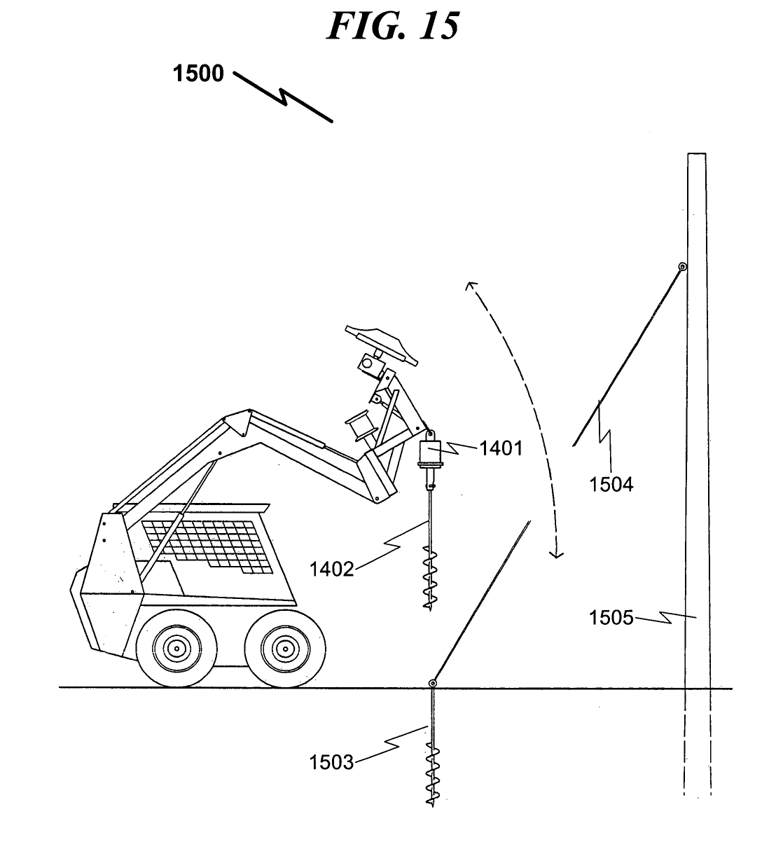

FIG. 14 (1400) and FIG. 15 (1500) illustrate how the present invention may be used with a drilling attachment (1401) to affect the placement of anchor screws (1402) and the like for use in securing the placement of utility poles. Here the utility pole anchor (1402) is attached to a rotating motor means (1401) used to provide torque to spin and secure the guy wire anchor (1402). Once the guy wire anchor (1402) has been placed (1503) it may be secured via the use of a cable (1504) or other securing means to the utility pole (1505) as illustrated in FIG. 15 (1500).

Note that the rotating motor means (1401) as shown in this embodiment is a separate attachment that is connected to the structural frame via the hooking means (0205). However, as previously mentioned, the rotating motor means (0203) utilized to articulate the pole attachment means (0262) may also be used for this purpose if the pole attachment means (0203) is removed from the rotating motor means (0203). One skilled in the art will quickly realize that the use of a single drilling/augering/placement motor means is highly desirable for cost and weight considerations for the present invention, but is not absolutely a requirement for proper installation of utility poles using the teachings of the present invention.

### Exemplary Transformer Installation (1600, 1700, 1800, 1900)

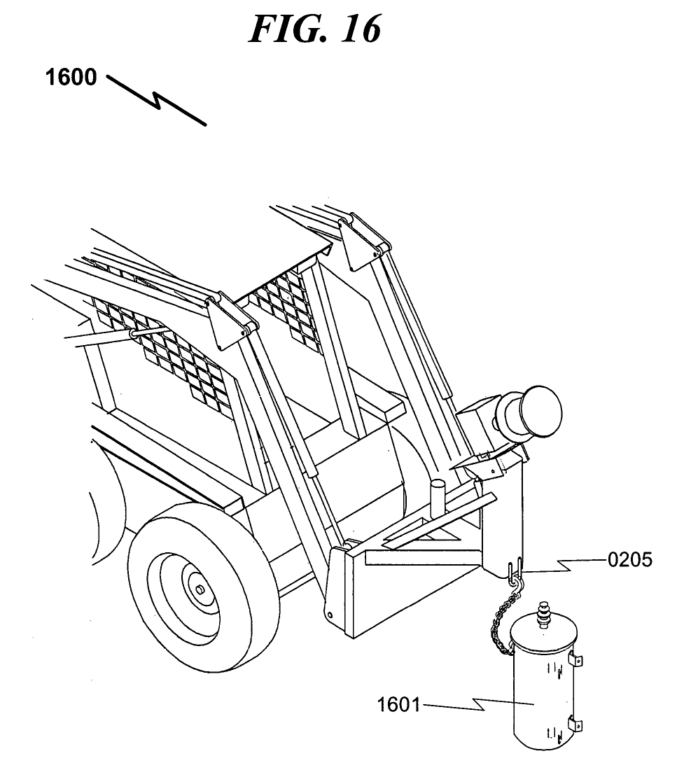

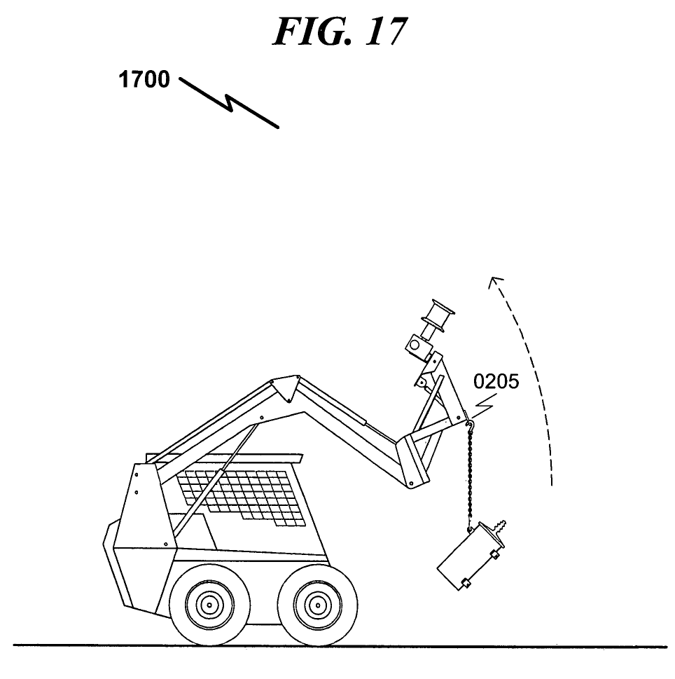

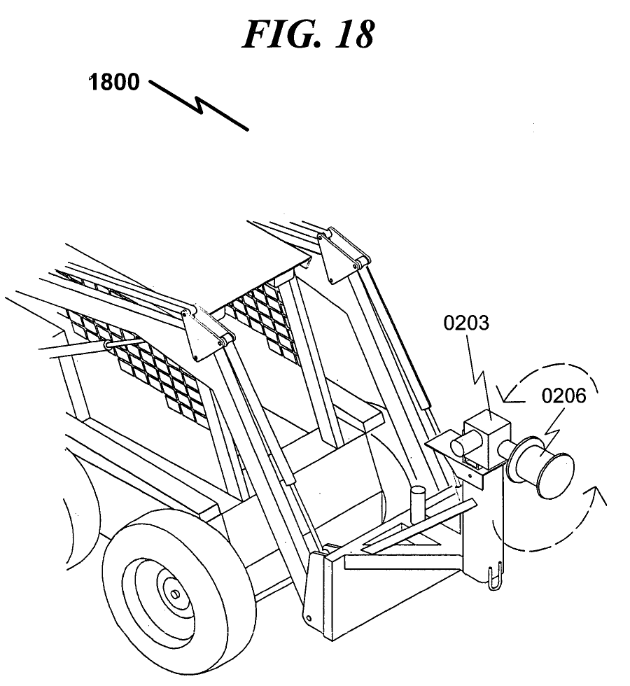

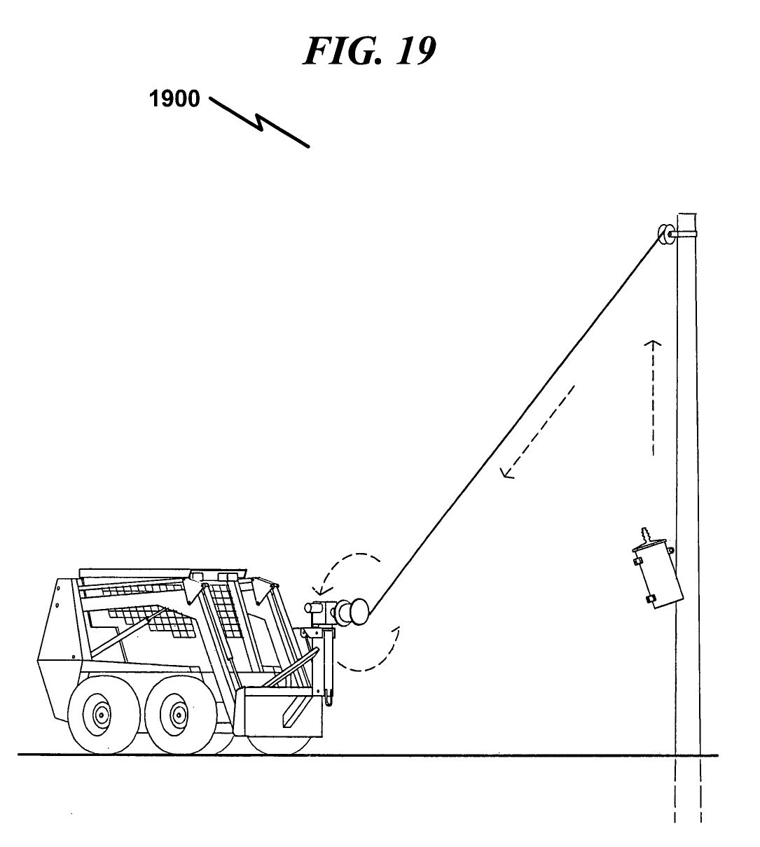

FIG. 16 (1600), FIG. 17 (1700), FIG. 18 (1800), and FIG. 19 (1900) illustrate how the present invention may be used to place a transformer (1601) or other equipment on top of an existing utility pole by using a friction winch pulley attachment (0206) for the rotating motor means (0203) and thus affect a mechanism for lifting heavy transformers or other equipment to the top of an existing utility pole. Here the transformer is too heavy to be lifted without the aid of some mechanical device, and the attachment (0206) provided for the rotating motor means (0203) permits one or more operators to affect installation without the need for heavy equipment. Additionally, the process as illustrated does not require significant commitment of expensive heavy equipment such as cranes and the like.

Note that the hooking means (0205) may be used as illustrated in FIG. 16 (1600) and FIG. 17 (1700) may be used to lift the transformer (1601) for placement proximal to the utility pole prior to placement of the transformer on the utility pole.

### Exemplary Method Embodiment (2000)

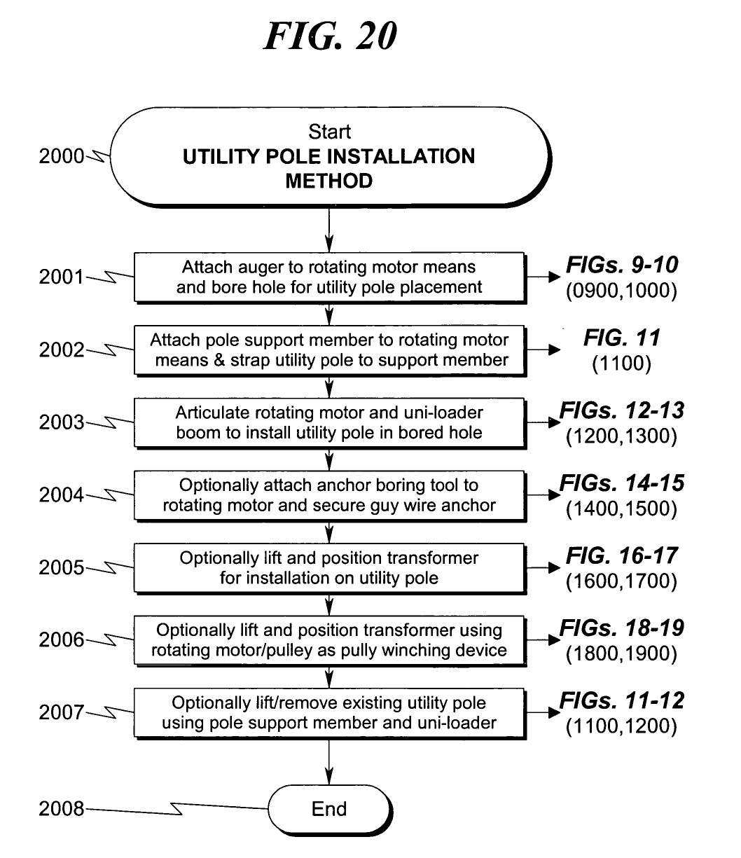

The present invention teaches a generalized utility pole installation method which is generally illustrated in FIG. 20 (2000) and includes the following steps:
1. Attaching an auger and/or boring tool to a rotating motor means attached to the present invention system and boring a hole for the utility pole placement (2001). Note that the rotating motor means may either be a separate attachment attached to a hook support means (0205) attached to the support frame (0201), or it may utilize the rotating motor means (0203) that is already attached to the support frame (0201);
2. Attaching a pole support member to the rotating motor means and strapping or securing the utility pole to the support member (2002). Note here that a variety of means may be used to support the attachment of the utility pole to the utility pole support means as detailed previously;
3. Articulating the rotating motor means and uni-loader boom to position and place the utility pole in the previously bored earthen hole (2003).
4. Optionally attaching another boring tool to a rotating motor means attached to the support frame for the purposes of securing a guy wire anchor into the earth (2004).
5. Optionally lifting and positioning a transformer near the utility pole for installation on the utility pole (2005).
6. Optionally lifting and positioning a transformer on the utility pole using the rotating motor means and a pulley as a pulley winching device (2006).
7. Optionally lifting and removing existing utility pole using the pole support member and the uni-loader (2007). Note in some circumstances the uni-loader may either lift the replaced utility pole or simply drag this pole from the scene using the optional hook support means (0205) and a chain or other securing device.
   At the end of this procedure, the utility pole is installed and ready for connection to the utility grid.

One skilled in the art will recognize that these steps may in some circumstances be rearranged with no loss of function with respect to application in the field of utility pole installation.

### System Variations

The present invention anticipates a wide variety of variations in the basic theme of construction. The examples presented previously do not represent the entire scope of possible usages. They are meant to cite a few of the almost limitless possibilities.

### Environmental Considerations

The present invention significantly improves the environment in a number of ways, including but not limited to the following:
The present invention permits rapid installation of FIBERGLAS® poles, a replacement for wood poles.

The present invention reduces the toxic Creosote used in conventional wood pole installations.

The present invention drastically reduces the number of trees and vegetation which must be cleared to install utility poles in wooded areas. The small form factor of the uni-loader used with the present invention to facilitate utility pole installation means that a significantly reduced amount of vegetation must be removed to affect utility pole installation.

One skilled in the art will no doubt find other reasons that the present invention improves the environment, not limited to those listed above.

### CONCLUSION

A utility pole installation system and method has been disclosed which permits utility poles to be installed via the use of a uni-loader or similar device in areas that are space constrained. Specifically, the present invention is advantageously applied to situations where thick brush or other vegetation makes installation and/or replacement of utility poles difficult. The present invention integrates the utility pole installation function by permitting a single uni-loader attachment to (a) drill the earth holes necessary for utility pole installation, (b) place the utility pole in the drilled earthen hole, (c) install necessary guy wire anchors necessary to maintain utility pole stability, and (d) lift transformers and/or other equipment to the top of the utility pole for attachment to the utility pole.

The present invention incorporates a structural frame for attachment to a uni-loader, a pole attachment means coupled with a rotating motor means and an articulating piston means to permit manipulation of the utility pole in multiple degrees of freedom, permitting placement of the utility pole in space constrained environments, such as those associated with replacement of existing utility poles or other utility structures.

Although a preferred embodiment of the present invention has been illustrated in the accompanying drawings and described in the foregoing detailed description, it will be understood that the invention is not limited to the embodiments disclosed, but is capable of numerous rearrangements, modifications, and substitutions without departing from the spirit of the invention as set forth and defined by the following claims:

1. A utility pole installation system comprising:
(a) a structural frame for attachment to a front-loader;
(b) a pole attachment means;
(c) a rotating motor means coupled to said pole attachment means and connected to said structural frame;
(d) an articulating piston means attached to said rotating motor means and said structural frame permitting said pole attachment means to be moved to the front or rear of said uni-loader;
wherein
said rotating motor means and said articulating piston means permits said pole attachment means to be moved with several degrees of freedom to permit placement of a utility pole in space constrained environments.

2. The utility pole installation system of claim 1 further comprising a lifting hook means connected to said structural frame used to lift and position heavy objects.

3. The utility pole installation system of claim 1 further comprising a lifting hook means connected to said structural frame used to position a rotating motor means used to rotate drill bits for the purpose of drilling an earthen hole for placement of said utility pole.

4. The utility pole installation system of claim 1 further comprising a storage axle connected to said structural frame used to store a pulley winch.

5. The utility pole installation system of claim 1 further comprising a pulley winch used to position transformers on said utility pole.

6. The utility pole installation system of claim 1 wherein said front-loader is a uni-loader.

7. The utility pole installation system of claim 1 wherein said rotating motor means is a hydraulic motor.

8. The utility pole installation system of claim 1 wherein said rotating motor means is an electric motor.

9. The utility pole installation system of claim 1 wherein said pole attachment means is detachable from said rotating motor means, permitting said rotating motor means to rotate a drill bit for boring utility pole holes in the earth.

10. The utility pole installation system of claim 1 wherein said pole attachment means is detachable from said rotating motor means, permitting said rotating motor means to rotate and place earthen screw anchors to stabilize utility poles after placement of said utility pole.

11. A utility pole installation method comprising:
(1) drilling an earthen hole for a utility pole utilizing a drill bit rotated by a rotating motor means connected to a structural frame attached to a front-loader;
(2) attaching said utility pole to a pole attachment means positioned by a rotating motor means connected to a structural frame attached to a front-loader;
(3) positioning said pole attachment means with a rotating motor means and a piston articulation means connected to a structural frame attached to a front-loader;
(4) placement of said utility pole in said earthen hole using said positioning;
(5) installation of transformer equipment on said utility pole using said rotating motor means rotating a pulley winch; and
(6) optional installation of guy wires and/or earthen anchors using a rotating motor means to secure screw anchors into the earth.

12. The utility pole installation method of claim 11 wherein a lifting hook means connected to said structural frame is used to lift and position said transformer.

13. The utility pole installation method of claim 11 wherein a lifting hook means connected to said structural frame is used to position a rotating motor means used to rotate drill bits for the purpose of drilling an earthen hole for placement of said utility pole.

14. The utility pole installation method of claim 11 wherein a storage axle connected to said structural frame is used to store a pulley winch.

15. The utility pole installation method of claim 11 wherein a pulley winch is used to position transformers on said utility pole.

16. The utility pole installation method of claim 11 wherein said front-loader is a uni-loader.

17. The utility pole installation method of claim 11 wherein said rotating motor means is a hydraulic motor.

18. The utility pole installation method of claim 11 wherein said rotating motor means is an electric motor.

19. The utility pole installation method of claim 11 wherein said pole attachment means is detachable from said rotating motor means, permitting said rotating motor means to rotate a drill bit for boring utility pole holes in the earth.

20. The utility pole installation method of claim 11 wherein said pole attachment means is detachable from said rotating motor means, permitting said rotating motor means to rotate and place earthen screw anchors to stabilize utility poles after placement of said utility pole.
